(19) United States
(12) Patent Application Publication
(10) Pub. No.: US 2014/0164892 A1
(43) Pub. Date: Jun. 12, 2014

(54) CONSUMING CONTENT INCREMENTALLY

(71) Applicant: MICROSOFT CORPORATION, REDMOND, WA (US)

(72) Inventors: RADOSLAV NICKOLOV, SEATTLE, WA (US); MING LIU, BELLEVUE, WA (US); WEI ZENG, SAMMAMISH, WA (US); RAMAN NARAYANAN, SEATTLE, WA (US)

(73) Assignee: MICROSOFT CORPORATION, REDMOND, WA (US)

(21) Appl. No.: 13/711,098

(22) Filed: Dec. 11, 2012

(51) Int. Cl. G06F 17/22; G06F 17/21

(52) U.S. Cl. CPC G06F 17/2235; G06F 17/218
USPC 715/205; 715/234

(57) ABSTRACT

An e-reader application consumes content incrementally during presentation. The application determines a location of another page in the content in response to a user action to load the other page in place of a currently displayed page. A user initiates navigation to the other page by activating a navigation control to display an adjacent page or a random page of the content. An increment of the content containing the other page is retrieved from the determined location. An anchor associated with the other page can be used to find the location in the content. The increment is processed to extract the other page. Processing can include decoding the increment using a standard format used to store the increment. The extracted page is displayed by the application while unloading the previously displayed page from system memory.

### BACKGROUND

Mobile computing has transformed media consumption across markets. Miniaturization across product generations has enabled more functionality to be accomplished by smaller devices. A modern smartphone has more computing capacity than a desktop computer a few years ago. Mature product processes have also enabled advances in technology to be integrated to automated production of mobile devices seamlessly. Extensive automation has led to inexpensive components. Inexpensive components have enabled manufacturing of inexpensive mobile devices providing functionality on the go.

Content presentation in mobile devices has significant room for improvement. Navigation from a displayed portion to other areas in the content can be a uneven experience. Stutter during transition from one page to another while viewing the content can take away from the user experience. A malformed new page also can disrupt a user flow while consuming the content.

Variety of reasons can lead to a disruption of the user experience while consuming the content. Switching from content format to another usually leads to a pause for processing the new format. Loading resource rich content can also tie up device resources in order to format and render the content. Buffering multiple content pages can exasperate the user experience by slowing down the device used to consume the content. Server based rendering can improve responsiveness. However, in spite of server based rendering, rapid consumption of rich content can still slow down a device unable to process complex media.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to consuming content incrementally, for example, during a presentation. According to some embodiments, an application of an e-reader device may display a page from hosted content. The content may include any media that is partitioned to pages or segments. A user action may be detected to load another page or segment of the content. Next, a location of the other page in the content may be determined by accessing the content at the content source and traversing through the content to locate the other page. An increment of the content such as a page or a portion of the content defined by a system setting (e.g., a chapter) may be retrieved from the location. The application may then process the increment to extract the other page, which may be displayed after processing.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example architectural diagram of consuming content incrementally during presentation in an e-reader according to some embodiments;

FIG. 2 illustrates an example e-reader device consuming content incrementally during presentation according to embodiments;

FIG. 3 illustrates steps of consuming content incrementally during presentation in an e-reader according to embodiments;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process consuming content incrementally during presentation in an e-reader according to embodiments.

### DETAILED DESCRIPTION

As briefly described above, content may be consumed incrementally during presentation in an e-reader device. An application of an e-reader device may determine a location of another page in content in response to detecting a user action to load the other page while displaying a page of the content. An increment of the content may be retrieved from the location and processed to extract and display the other page.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for consuming content incrementally during presentation. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

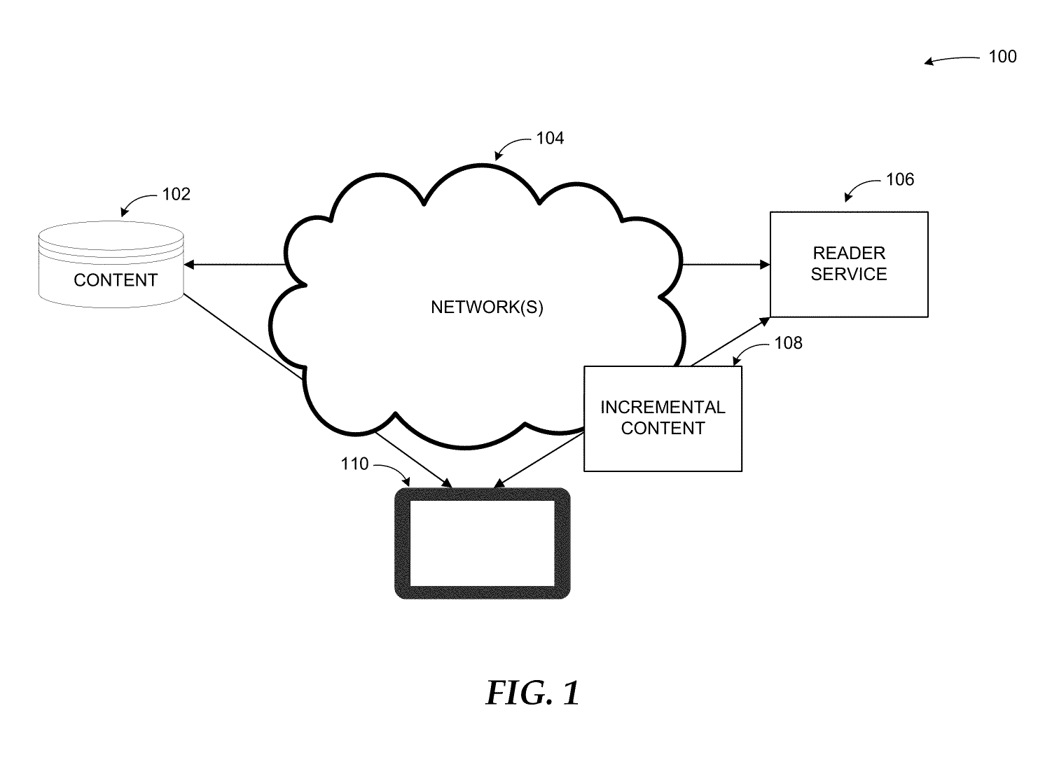

FIG. 1 illustrates an example architectural diagram of consuming content incrementally during presentation in an e-reader according to embodiments. The components and environments shown in diagram 100 are for illustration purposes. Embodiments may be implemented in various local, networked, cloud-based and similar computing environments employing a variety of computing devices and systems, hardware and software.

An “e-reader” device such as a tablet 110 may host an application providing incremental content 108 to a user. Such an application may be called an e-reader application, which may be a locally installed and executed application receiving content (e.g., e-books, documents, etc.) through wired or wireless networks. The e-reader application may also be a hosted service 106 provided by one or more servers and accessed by a user through the e-reader device (e.g., tablet 110). Content may be any type of consumable data including but not exclusive to text, audio, video, graphic, etc. Content may also include media combinations presented in a standardized format (e.g., a web page.) Content may be provided by a content server 102 hosting the content for consumption by services and devices.

An application according to embodiments may be a standalone application executed in a tablet device 110. A standalone application may retrieve incremental content directly from the content server 102. Alternatively, the application may be a distributed application with multiple components. In an example scenario, the application may have a client component executed in tablet 110. A reader service component 106 may be executed separately from the client component and manage content retrieval and processing.

Embodiments are not limited to implementation in a tablet 110. An application according to embodiments may process content incrementally during presentation in other platforms. A user may navigate through content incrementally in any device capable of displaying the content. A touch enabled device (although preferable) is not necessary. A user may access incremental content using a standard mouse and keyboard interface.

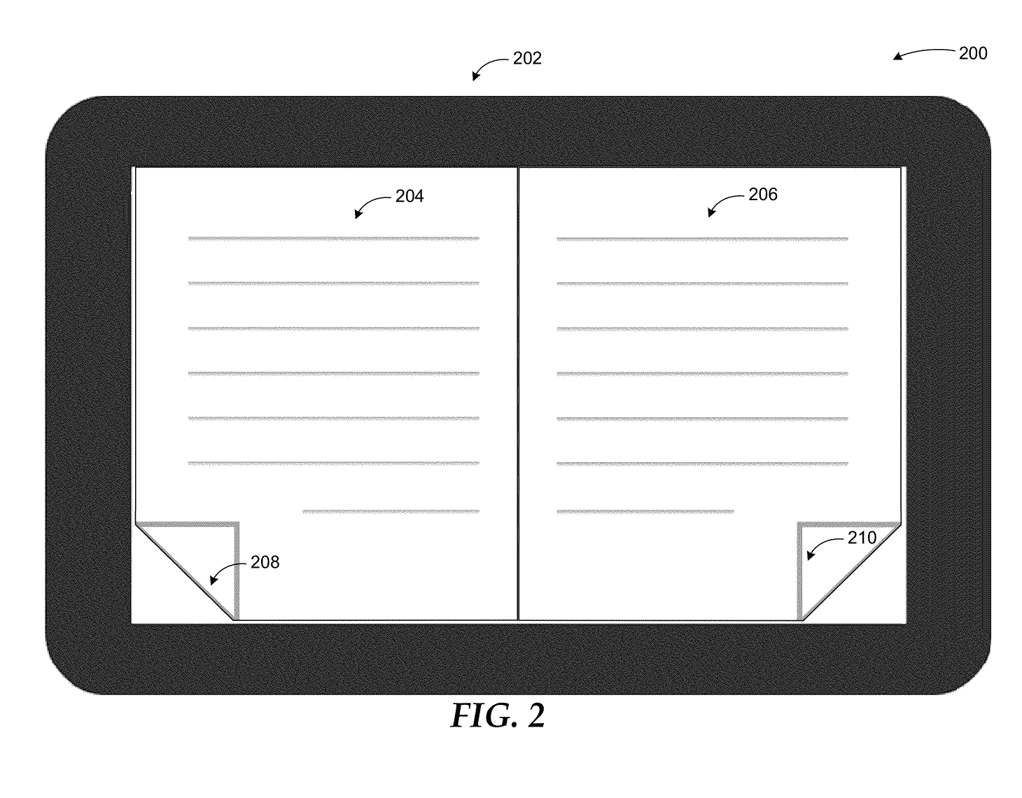

FIG. 2 illustrates an example e-reader device consuming content incrementally during presentation according to embodiments. Diagram 200 displays an application of an e-reader device presenting content incrementally.

A mobile device such as tablet 202 may display content through an e-reader application. The content may be partitioned to pages. Multiple pages 204 and 206 may be displayed through the tablet 202. In addition, navigation controls 208 and 210 may provide navigation functionality. The navigation controls 208 and 210 are examples for illustration purposes. Additional navigation control may be provided through horizontal touch swipes, keyboard strokes like arrow-left/page-up and arrow-right/page-down, a page location slider, or similar techniques. A page as used herein refers to any predefined segment of content. Such segments may be of any size depending on application and/or device type, available display space, and similar parameters.

In response to detecting an activation of the navigation control 208, the application may contact the content resource to determine a location of an increment prior to page 204. The determined increment may be retrieved from the content source. If the increment encapsulates a single page, the increment may be processed for presentation in place of page 204. If the increment encapsulates multiple pages, the increment may be processed to extract the previous page. Next, the previous page may be displayed in place of page 204 and page 204 may be displayed in place of page 206. The page 206 may be unloaded from a local resource, including a memory segment, since it is no longer in active display.

In response to detecting an activation of the navigation control 210, the application may contact the content resource to determine a location of an increment next to page 206. The location may be determined by seeking an anchor to the other page in the content. The anchor may be stored within a link to the other page. The determined increment may be retrieved from the content resource. A subsequent page in the increment may be displayed in place of page 206. Page 206 may be displayed in place of page 204. The page 204 may be unloaded from a local resource since it is no longer in active display.

Content may be formatted in a standard format such as hypertext markup language (html). The content may be partitioned into increments by the content resource. An increment may include a chapter. The increment may also be a single page.

The increment may be processed to retrieve a requested page for display. Processing may include decoding the increment using the format of the increment. Next, the requested page may be extracted from the decoded increment and prepared for display according to specifications of the display device. In addition, the prior page may be unloaded in response to displaying the requested page.

Content may be processed incrementally starting from the current reading position. The processing may be propagated forwards and backwards depending on the user action requesting the next page. Processed priority may be based on distance from the current location. The user action to navigate may include sequential request for a page such as a previous and a next page. In addition, the user action may request to display a page out of sequence such as a page available through a link in a table of contents. The user action may include an activation of a hyperlink to retrieve an increment containing the page.

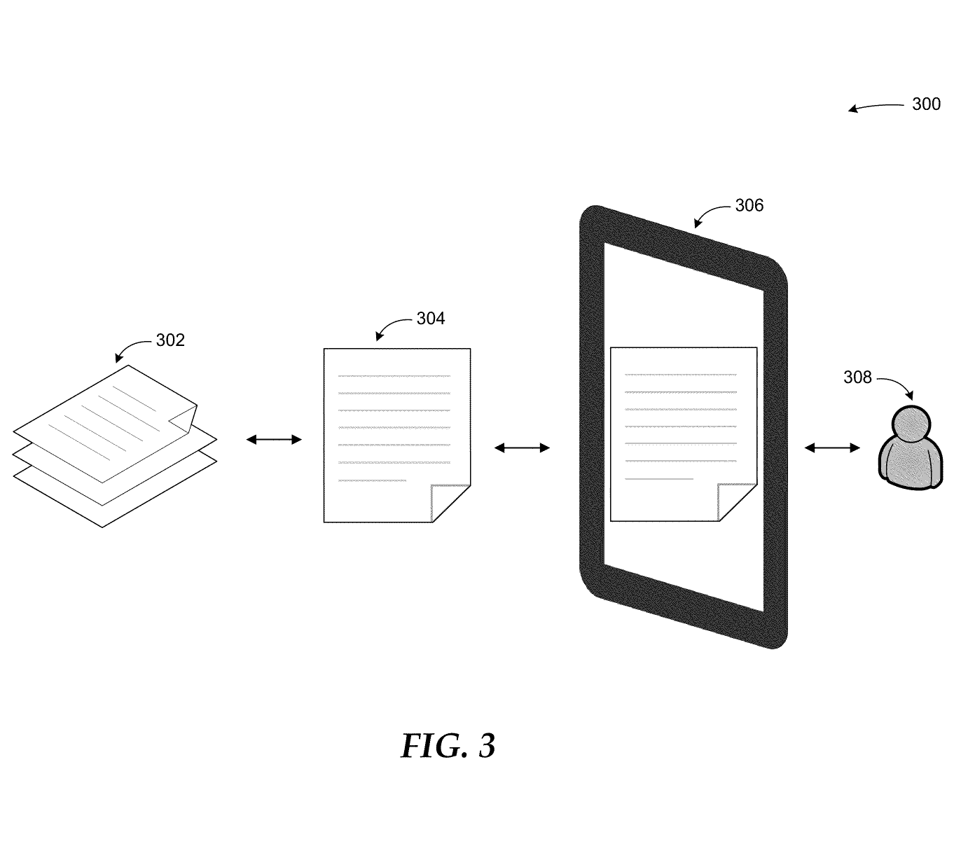

FIG. 3 illustrates steps of consuming content incrementally during presentation in an e-reader according to embodiments. Diagram 300 displays an e-reader device 306 displaying a page from an increment 304 retrieved from content 302.

An e-reader application executed in device 306 may respond to a user action to navigate to another page in the content 302. The user action may be instigated by a user 308 by interacting with a navigation control of the e-reader application. The application may determine a location of the requested page in the content 302. Upon determining the location, the application may retrieve the increment 304 from the content 302 from the location.

The increment may be processed to prepare the requested page for display by the e-reader application. An example process may include decoding a format of the increment. In an example scenario the increment may be formatted in extensible markup language (xml) or html. The application may decode the xml formatted increment and extract the requested page. The requested page may be formatted in a rendering format. The rendering format may include html. In addition, the requested page may be processed to match display characteristics of the currently displayed page. The display characteristics may include font size, font color, font type, etc.

If the increment includes multiple pages of the content, the processing may be prioritized based on proximity to the requested page. A page adjacent to the requested page may be assigned a high priority for processing. A page distant from the requested page may receive a low priority for processing.

Each page may be processed using real page numbers. In an example scenario, a requested page may be provided an associated page number. If the requested page is adjacent to the currently presented page, the requested page may be provided with an incremented or decremented page number in relation to the page number of the currently presented page. If the user action requests a page away from the currently displayed page, the page number may be extracted from the increment retrieved from the content resource. In addition, the page number may be displayed according to a predetermined system specification. An example may include middle of a footer of the page.

The example scenarios and schemas in FIG. 2 through 3 are shown with specific components, data types, and configurations. Embodiments are not limited to systems according to these example configurations. Consuming content incrementally during presentation in an e-reader may be implemented in configurations employing fewer or additional components in applications and user interfaces. Furthermore, the example schema and components shown in FIG. 2 through 3 and their subcomponents may be implemented in a similar manner with other values using the principles described herein.

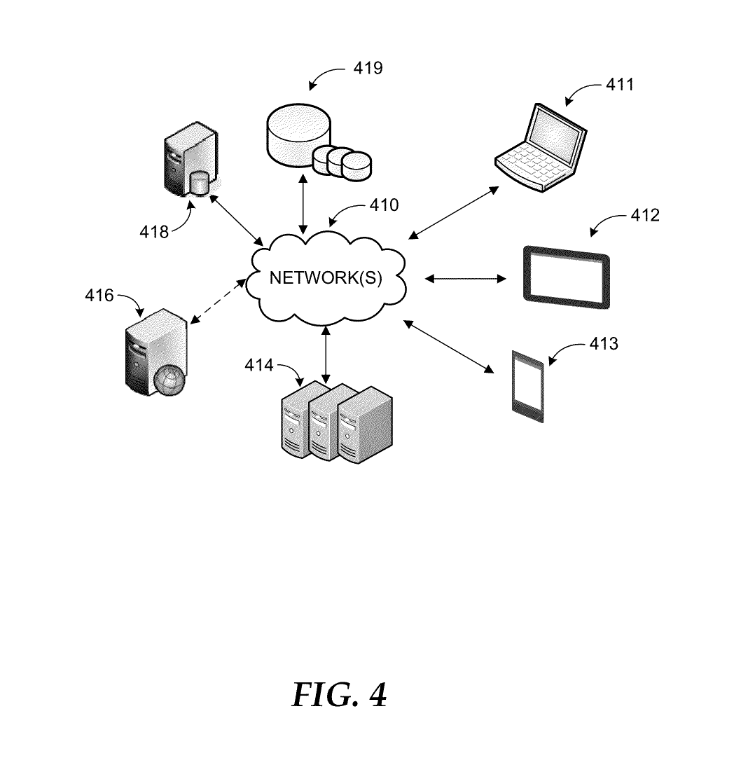

FIG. 4 is a networked environment, where a system according to embodiments may be implemented. Local and remote resources may be provided by one or more servers 414 or a single server (e.g. web server) 416 such as a hosted service. An application may execute on individual computing devices such as a smart phone 413, a tablet device 412, or a laptop computer 411 (‘client devices’) and communicate with a content resource through network(s) 410.

As discussed above, an e-reader application may determine a location of another page within content in response to a detected user action to load the other page in place of a currently displayed page. The application may retrieve and process an increment from the location within the content to extract the other page. The processed page may be displayed in an e-reader device. Client devices 411-413 may enable access to applications executed on remote server(s) (e.g. one of servers 414) as discussed previously. The server(s) may retrieve or store relevant data from/to data store(s) 419 directly or through database server 418.

Network(s) 410 may comprise any topology of servers, clients, Internet service providers, and communication media. A system according to embodiments may have a static or dynamic topology. Network(s) 410 may include secure networks such as an enterprise network, an unsecure network such as a wireless open network, or the Internet. Network(s) 410 may also coordinate communication over other networks such as Public Switched Telephone Network (PSTN) or cellular networks. Furthermore, network(s) 410 may include short range wireless networks such as Bluetooth or similar ones. Network(s) 410 provide communication between the nodes described herein. By way of example, and not limitation, network(s) 410 may include wireless media such as acoustic, RF, infrared and other wireless media.

Many other configurations of computing devices, applications, data sources, and data distribution systems may be employed to consume content incrementally during presentation in an e-reader. Furthermore, the networked environments discussed in FIG. 4 are for illustration purposes only. Embodiments are not limited to the example applications, modules, or processes.

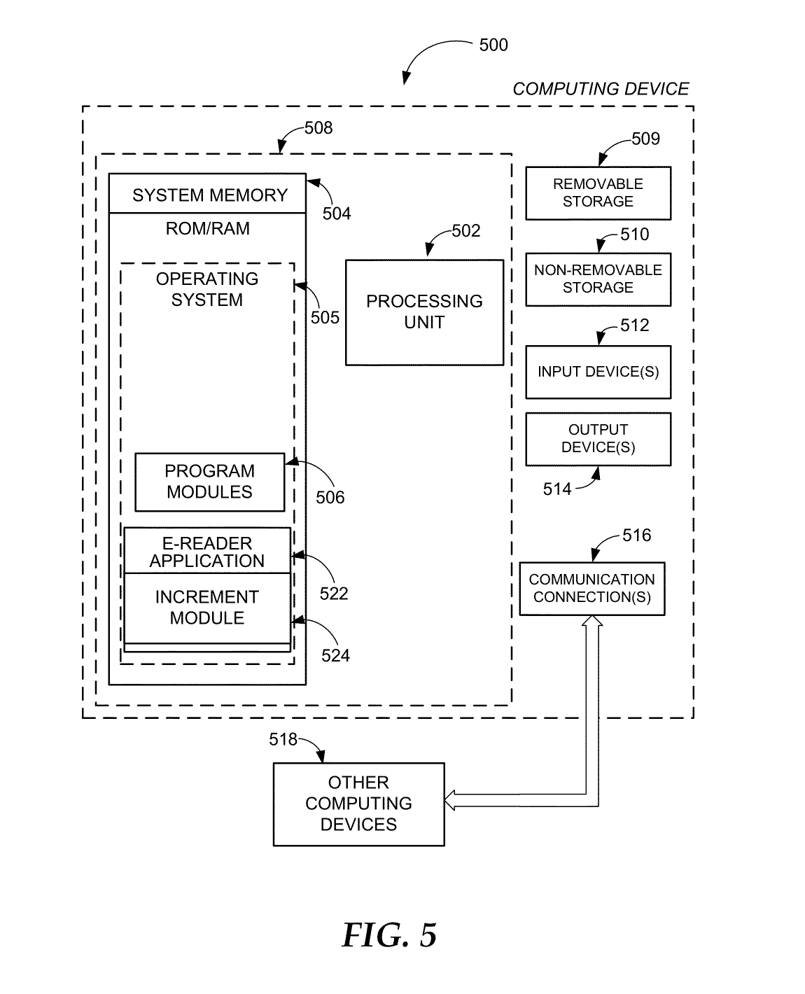

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS® and WINDOWS PHONE® operating systems from MICROSOFT CORPORATION of Redmond, Wash. The system memory 504 may also include one or more software applications such as program modules 506, an e-reader application 522, and an increment module 524.

An e-reader application 522 may detect a user action to load another page of content to replace a currently displayed page of the content. The application 522 may determine a location of the other page and retrieve an increment from the location. The increment module 524 may process the increment to extract the other page. Processing may include decoding the format of the increment and preparing the extracted page for display. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. Computer readable storage media is a computer readable memory device. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wireless network in a distributed computing environment, a satellite link, a cellular link, and comparable mechanisms. Other devices 518 may include computer device(s) that execute communication applications, storage servers, and comparable devices. Communication connection(s) 516 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

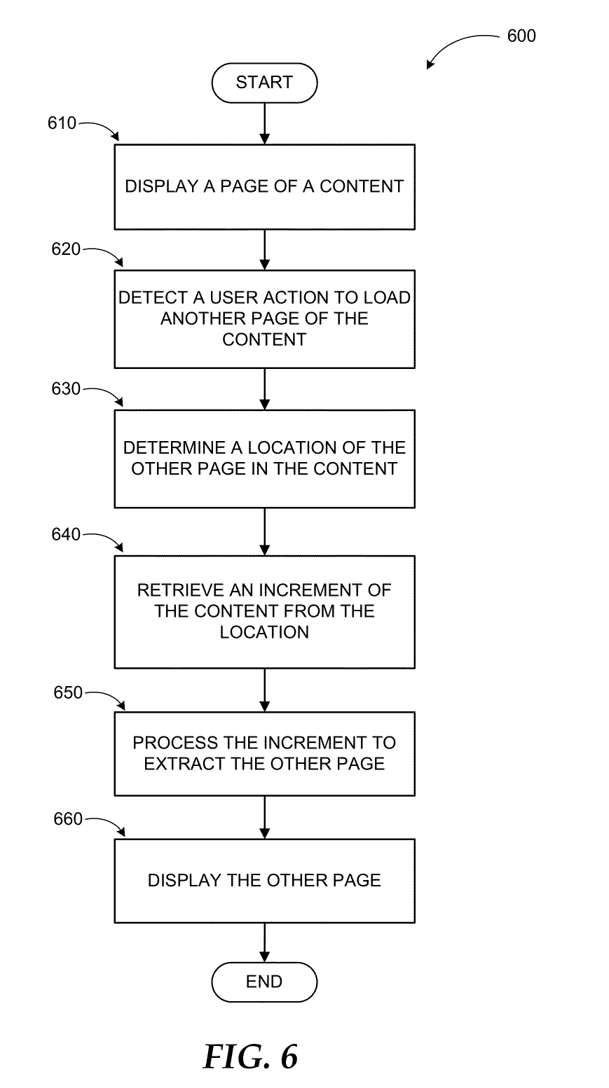

FIG. 6 illustrates a logic flow diagram for a process consuming content incrementally during presentation in an e-reader according to embodiments. Process 600 may be implemented by an e-reader application in some examples.

Process 600 may begin with operation 610 where the e-reader application may display a page of content. The page may include any media or combination of media. The application may detect a user action to load another page of the content at operation 620. The user action may include activation of a navigation control to load the other page. At operation 630, the location of the other page in the content may be determined The location may be determined by traversing the content to find the other page.

An increment of the content from the location may be retrieved at operation 640. The content may be partitioned to increments including one or more pages. An example increment may include a chapter. The increment may be processed to extract the other page at operation 650. The processing may include decoding the format of the increment and rendering the content to a display format. At operation 660, the other page may be displayed at the display device by the e-reader application.

Some embodiments may be implemented in a computing device that includes a communication module, a memory, and a processor, where the processor executes a method as described above or comparable ones in conjunction with instructions stored in the memory. Other embodiments may be implemented as a computer readable storage medium with instructions stored thereon for executing a method as described above or similar ones.

The operations included in process 600 is for illustration purposes. Consuming content incrementally during presentation, according to embodiments, may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for consuming hosted content incrementally, the method comprising:
displaying a page of the content;
detecting an action to view another page of the content;
determining a location of the other page in the content;
retrieving an increment of the content from the location;
processing the increment to extract the other page; and
displaying the other page.

2. The method of claim 1, further comprising:
detecting the action from an activation of a navigation control to load the other page.

3. The method of claim 1, further comprising:
traversing the content at a content source to determine the location.

4. The method of claim 3, further comprising:
retrieving an anchor from a link to the other page;
seeking the anchor within the content at the content source to determine the location.

5. The method of claim 1, further comprising:
in response to detecting an activation of a navigation control to load the other page, retrieving the increment from the location before a subsequent location of the page.

6. The method of claim 1, further comprising:
in response to detecting an activation of a navigation control to load the other page, retrieving the increment from the location after a previous location of the page.

7. The method of claim 1, further comprising:
retrieving the increment including multiple pages; and
decoding the increment using a format of the increment.

8. The method of claim 7, further comprising:
extracting the other page from the decoded increment; and
rendering the other page for display.

9. The method of claim 7, further comprising:
decoding the increment using a standard format including at least one of: extensible markup language (XML) and hypertext markup language (HTML).

10. The method of claim 1, further comprising:
extracting the other page from the increment encompassing a chapter.

11. The method of claim 1, further comprising:
extracting the other page from the increment encompassing a single page.

12. An e-reader device for consuming hosted content incrementally, the e-reader device comprising:
a memory configured to store instructions; and
a processor coupled to the memory, the processor executing an application in conjunction with the instructions stored in the memory, wherein the application is configured to:
display a first page of the content;
detect an action to load a second page of the content;
determine a location of the second page in the content using a process to:
retrieve an anchor from a link to the second page;
seek the anchor within the content to determine the location;
retrieve an increment of the content from the location;
process the increment to extract the second page; and
display the second page.

13. The e-reader device of claim 12, wherein the application is further configured to:
match at least one display characteristic of the second page to the first page including at least one of: a font size, a font color, and a font type.

14. The e-reader device of claim 12, wherein the application is further configured to:
assign an adjacent page in relation the second page in the increment a high priority for processing.

15. The e-reader device of claim 12, wherein the application is further configured to:
assign a distant page in relation to the second page in the increment a low priority for processing.

16. The e-reader device of claim 15, wherein the application is further configured to:
remove the first page from a local resource including a memory segment in response to displaying the second page.

17. A computer-readable memory device with instructions stored thereon for consuming hosted content incrementally, the instructions comprising:
displaying a first page of the content;
detecting a user action to load a second page of the content;
determining a location of the second page in the content by:
retrieving an anchor from a link to the second page;
seeking the anchor within the content to determine the location;
retrieving an increment of the content from the location;
processing the increment to extract the second page;
matching at least one display characteristic of the second page to the first page including at least one of: a font size, a font color, and a font type; and
displaying the second page.

18. The computer-readable memory device of claim 17, wherein the instructions further comprise:
presenting a page number while displaying the second page.

19. The computer-readable memory device of claim 18, wherein the instructions further comprise:
retrieving the page number associated with the second page from the increment.

20. The computer-readable memory device of claim 18, wherein the instructions further comprise:
incrementing a current page number of the first page to determine the page number if the first page is adjacent and prior in relation to the second page in the content; and
decrementing a current page number of the first page to determine the page number if the first page is adjacent and next in relation to the second page in the content.
